(19) United States
(12) Patent Application Publication
(10) Pub. No.: US 2002/0190889 A1
(43) Pub. Date: Dec. 19, 2002

(54) Metal foams for low radar observability surfaces

(76) Inventors: George W. Webb, Del Mar, CA (US); Susan G. Angello, Bonita, CA (US)

Correspondence Address: Thomas W. Adams, Renner, Otto, Boisselle & Sklar, LLP, 1621 Euclid Avenue, Nineteenth Floor, Cleveland, OH, 44115, US

(21) Appl. No.: 09/998,150

(22) Filed: Nov. 30, 2001

Related U.S. Application Data
(60) Provisional application No. 60/255,189, filed on Dec. 12, 2000.

(51) Int. Cl. H01Q 17/00

(52) U.S. Cl. 342/1; 342/2; 342/3; 342/4

(57) ABSTRACT

The present invention relates to a material of construction which includes a radar-dispersing metal foam, and to a vehicle to which a radar-dispersing metal foam has been applied. The radar-dispersing metal foam is capable of reducing the radar return from an object by a significant amount over a wide range of radar frequencies. The metal foam has a very low reflectivity to incident radar wave radiation.

### BACKGROUND OF THE INVENTION

1. Field of the Invention

The present invention relates metal foams and their use on surfaces of vehicles and other objects to reduce their observability to radar.

2. Background

In a practice, radar waves from a distant emitter which are incident on a surface can be regarded as plane waves, or alternatively as a beam of co-linear rays all of the same phase. In the situation having the strongest radar return, namely an incident beam at normal incidence onto a flat metal surface, a beam of roughly co-linear rays all of the same phase is specularly reflected back in the direction of the radar emitter. This situation would produce a very strong radar return to the emitter.

Radar frequencies are generally in the microwave or millimeter wave bands having frequencies from about 1 GHz to about 100 GHz. As used herein, the term “radar” or “radar wave” is defined to include all radar or microwave radiation, regardless of the exact wavelength or frequency.

There are many instances when it is desired to reduce the reflected high frequency radar return or “echo” from a surface. The following are examples of applications in which it may be desired to reduce the radar return from a surface. In military applications, friendly land, air, or water vehicles may be subjected to radar by an enemy in order to make vehicles visible so that they can be attacked, thus the radar return signal is sought to be reduced. Another application is the reduction of interfering radar signals reflected from walls and other objects during testing in radar test chambers. Other applications include shielding radar-sensitive apparatus from radar-generating apparatus, and shielding structures adjacent or near radar generating apparatus when such structures may generate false echoes. A related civilian radar application is the reduction of radar return when automobiles and trucks are subjected to police radar.

In the past, materials have been developed for application to surfaces to reduce the magnitude of radar return signals. Historically these materials have been described by the general term of radar absorbing material. There have been two broad categories of radar absorbing material, namely resonant and non-resonant radar absorbers. See for example the publication, “Radar-Absorbing Material: A Passive Role in An Active Scenario” by Richard N. Johnson, which is available on the Internet at the following URL: http://www.randf.com/ramapriaas3.html, (the Internet version was reprinted from The International Countermeasure Handbook, 11th Ed.). Resonant materials such as the Salisbury screen or lossy elastomers are strongly absorbing over a restricted band of frequencies around a center design frequency. In some cases one material can be designed to be resonant over two frequency bands. The other group, nonresonant absorbers, is based on graded dielectric foams containing carbon.

Resonant materials have the disadvantage that they are narrow band; they are strongly absorbing over a narrow band of frequencies, but they are much less absorbing outside of that band.

The non-resonant absorbers are broadband, but they have the disadvantage that they are mechanically weak and have to be supported. Both resonant and non-resonant absorbers generally have the disadvantage that they are flammable or combustible.

Thus, a need remains for a radar-dispersing material which is capable of reducing the radar return from an object over a wide range of radar frequencies, in an inexpensive, lightweight form.

### SUMMARY OF THE INVENTION

The present invention provides such a radar-dispersing material which is capable of reducing the radar return from an object. The material is inexpensive and lightweight. The metal foams of the present invention have a very low specular reflectivity to incident radar wave radiation. The metal foams of the present invention are effective over a wide range of radar frequencies.

Thus, in one embodiment, the present invention relates to a material of construction which includes a radar-dispersing metal foam. In one embodiment, the metal foam comprises open cells. In one embodiment, the open cells are formed by a reticulated backbone structure including a plurality of multiply connected ligaments. In one embodiment, the present invention relates to a vehicle having on a surface thereof a radar-dispersing metal foam.

In one embodiment, the metal foam of the present invention disperses radar return waves by a combination of scattering of incident radar waves from an emitter to a variety of different directions and by the randomization of the phase of radar waves reflected directly back to the emitter.

Thus, the present invention provides a solution to the problems of the prior art.

### BRIEF DESCRIPTION OF THE DRAWINGS

FIG. 1 is a photograph of an exemplary embodiment of a metal foam in accordance with the present invention.

FIG. 2 is a schematic diagram of three scenarios of radar waves interacting with internal elements of the metal foam in accordance with the present invention.

FIG. 3 is a schematic diagram of two methods of attaching to a substrate surface tiles of the metal foam of the present invention.

### DETAILED DESCRIPTION

In the present disclosure, the terms “radar dispersing” and “radar dispersion”, and similar uses of variations of the term “disperse” used with respect to radar waves, are defined to include one or more of reflection, diffraction, absorption, volume scattering, diffusive scattering and phase randomizing (i.e., rendering non-coherent) of radar waves, as a result of which the radar return signal received from an object is attenuated.

As noted above, radar frequencies generally cover a wide range of frequencies, for example radar may be considered to be in the microwave or millimeter wave bands having frequencies from about 1 GHz to about 100 GHz, or as high as 300 GHz. The following table shows typical radar carrier-frequency bands, according to commonly accepted nomenclature:

| Band | | Representative |
|---|---|---|
| Designation | Nominal Frequency Range | Wavelength, λ |
| HF | 3-30 MHz | 30 m @ 10 MHz |
| VHF | 30-300 MHz | 3 m @ 100 MHz |
| UHF | 300-1000 MHz (1 GHz) | 1 m @ 300 MHz |
| L | 1 GHz-2 GHz | 30 cm @ 1 GHz |
| S | 3-4 GHz | 10 cm @ 3 GHz |
| C | 4-8 GHz | 5 cm @ 6 GHz |
| X | 8-12 GHz | 3 cm @ 10 GHz |
| Kᵤ | 12-18 GHz | 2 cm @ 15 GHz |
| K | 18-27 GHz | 1.5 cm @ 20 GHz |
| Kₐ | 27-40 GHz | 1 cm @ 30 GHz |
| mm | 40-300 GHz | 0.3 cm @ 100 GHz |

Source: McGraw-Hill Concise Encyclopedia of Science & Technology, 2nd Ed. (1989), S. B. Parker, editor in chief.

In accordance with the present invention, in one embodiment, the present invention relates to a material of construction including a radar-dispersing metal foam. In one embodiment, the material of construction includes a metal foam in the shape of a tile or panel. The tile may have a relatively flat shape, or it may be curved. The tile generally has a length, a width and a thickness. The tile may be applied to a surface, such as an outer surface, of a vehicle or other object which is desired to be protected from detection by radar. In one embodiment, at least one metal foam tile having a plurality of open cells is applied to the surface of a vehicle or object to disperse impinging radar waves and thus reduce the radar return signal to the radar emitter. In one embodiment, the surface to which the metal foam is applied is an outer surface of the vehicle or object.

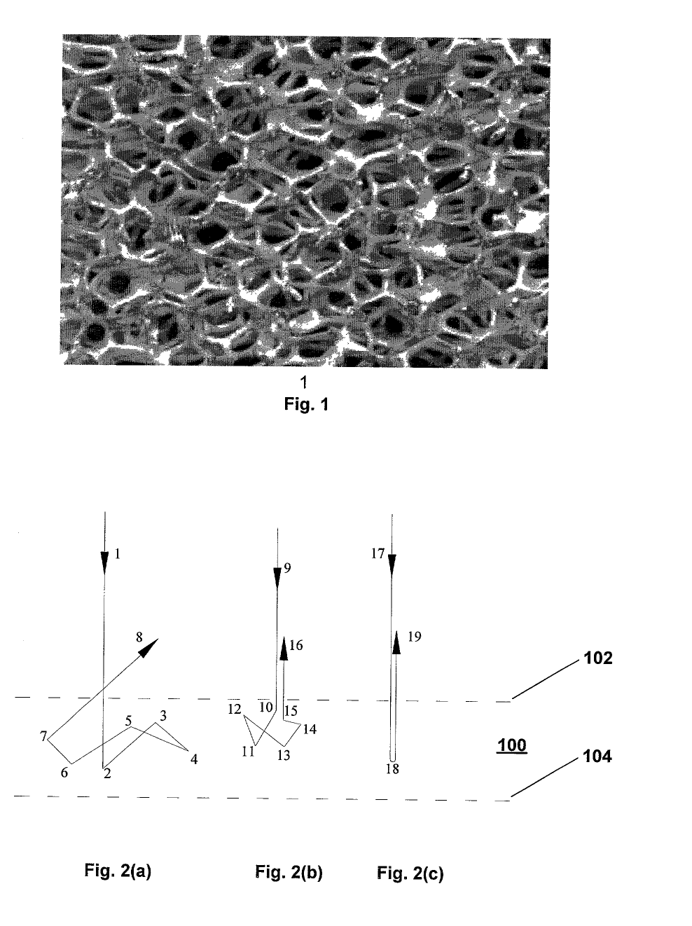

FIG. 1 is a photograph of an exemplary embodiment of a metal foam in accordance with the present invention. In the embodiment shown in FIG. 1, the metal foam has an average pore size in which there are about 10 pores per inch (“ppi”) (4 pores per cm, “ppcm”). In the foregoing, and in the entirety of the specification and claims, all range and ratio limits may be combined. As used herein, the term “cell” refers to a three-dimensional space defined by ligaments and internal elements of the metal foam. The term “pore” refers to an opening communicating between adjacent cells or to an opening communicating between a cell and the external environment. Thus, a cell may include a plurality of pores, and a pore may be shared by and communicate between two adjacent cells, or may communicate with the external environment. Incident radar waves enter the metal foam through the pores. Therefore, the pore size determines the wavelength of radar waves which can either pass through the pore or be reflected by the structures defining the pore.

In one embodiment, the metal foam is in the form of a tile which has a thickness in the range from about 0.1 cm to about 20 cm. Lesser thicknesses of the metal foam may not provide a sufficient number of radar dispersing surfaces, while a greater thickness may be impractical due to being too heavy and/or too expensive. In one embodiment, the thickness of the metal foam tile is in the range from about 0.5 to about 10 cm, in another embodiment, from about 1 cm to about 7 cm, and in yet another embodiment, from about 2 cm to about 5 cm.

Open cell metal foam, also called reticulated metal foam, is a metal structure of three dimensional interconnected polyhedron cells. A cell is typically comprised interconnected struts or ligaments, which form a three dimensional polyhedron, but which is substantially free of cell walls. A cell may be defined by any number of ligaments, e.g. from about 6 to at least about 15 ligaments. An open cell is a cell where no film or solid wall blocks spaces between the ligaments. Thus, in an open cell metal foam, there is free communication into and out of a cell. In an open cell metal foam, most or all adjacent cells are interconnected and form a three dimensional network of interconnected pores or cells. An open cell foam has a structure which typically comprises interconnected polyhedral cells, each cell having a spheroidal shape.

The size of the open cells may be varied from an average size in which there are about 0.5 pores per inch (ppi) (approximately equal to 0.2 pores per centimeter, ppcm) to an average of about 150 ppi (about 60 ppcm). In one embodiment, the average pore size ranges from about 5 ppi (2 ppcm) to about 100 ppi (40 ppcm). In another embodiment, the average pore size ranges from about 10 ppi (4 ppcm) to about 40 ppi (16 ppcm).

Due to its cellular structure, the metal foam has a density which is considerably reduced compared to the density of a solid piece of the material (referred to as the parent material) from which the foam is formed. The density of the foam may be referred to as a fraction of material density of the patent material. Thus, in one embodiment, the average density of the metal foam varies from about 2% to about 25% of the material density of the parent material. In another embodiment, the density of the metal foam varies from about 3% to about 20% of the material density of the parent material, and in another between about 5% and about 15% of the material density of the parent material. The material density of the metal foams is calculated by estimating the volume a metal foam would have if it were a solid object, by assuming that the metal foam has outer surfaces formed and defined by terminal ends of the ligaments of the metal foam. Thus, for example, a metal foam having dimensions of 12 in.×12 in.×1 in. (30.5 cm×30.5 cm×2.5 cm) would have a volume of 144 in³ (about 2360 cm³), the same as a solid piece of the material would have. Since it is a foam, the weight is considerably lower, therefore the material density is considerably lower.

The metal foams of the present invention may comprise one or more of a variety of materials: Al, Cu, Ni, Si, Ti, Fe, Pt, Ag, and alloys of two or more of these, and from such additional materials as steel, stainless steel, brass, Hastalloy, NiChrome, Inconel, FeCrAIY and vitreous carbon. In one embodiment, the term “metal foam” is broad enough to include semi-metallic materials such as the aforementioned vitreous carbon. Vitreous carbon is a glassy carbon as opposed to a graphitic carbon. The choice of metal will not strongly affect the radar performance due to the high electrical conductivity of the metals; however, the choice of optimum metal will be affected by the ambient conditions such as weather, presence of corrosives, and requirements of weight and cost. In one embodiment, the metal foam is non-combustible under normal operating conditions.

As discussed above, the metal foams of the present invention comprise open cells. In one embodiment, the metal foam comprises a plurality of radar-reflecting internal elements. The internal elements are the backbone structure and connective ligaments of the open cell structure. In one embodiment, the internal elements form a reticulated backbone structure of multiply connected ligaments. In one embodiment, the internal elements form a reticulated backbone structure of multiply connected ligaments which define the open cells in the metal foam.

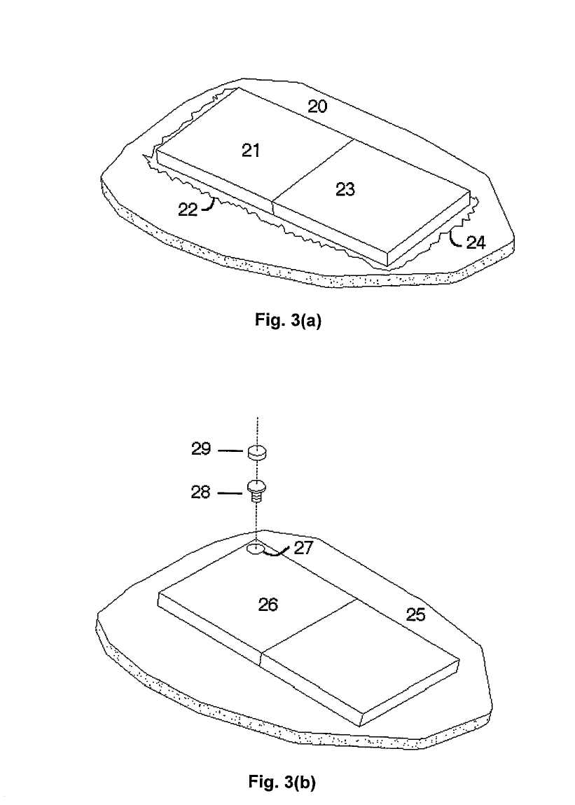

FIG. 2 is a schematic diagram of three scenarios of radar waves interacting with internal elements of the metal foam in accordance with the present invention. Here, for the sake of simplicity, we use the ray approximation to describe a radar wave in its interaction with the complicated foam structure. FIG. 2 schematically depicts a metal foam 100, defined by the dashed lines 102, 104.

In one embodiment, radar waves incident on the internal elements or ligaments are reflected in a plurality of directions. One such exemplary embodiment is shown in FIG. 2(a). As shown in FIG. 2(a), an incident radar ray 1 from a radar emitter enters the metal foam, striking and being reflected from a plurality of internal elements 2, 3, 4, 5, 6 and 7, before escaping the metal foam as an exit radar ray 8. The exit radar ray 8 corresponds to the incident radar ray 1 after it has been dispersed by the metal foam. The exit radar ray 8 is considered to have been dispersed in that it exits the metal foam in a direction which will not be returned to the emitter, and thereby will not be detected as a radar return from the object to which the metal foam 100 is applied. Where a plurality of such incident radar rays strike internal elements of the metal foam 100, in accordance with the present invention, in one embodiment substantially all of such rays are dispersed as described with reference to FIG. 2(a).

In one embodiment, at least about 90% of such incident rays are dispersed as described with reference to FIG. 2(a). In one embodiment, substantially all of the remaining 10% are reflected as described below. In one embodiment, at least about 95% of such incident rays are dispersed as described with reference to FIG. 2(a). In one embodiment, substantially all of the remaining 5% are reflected as described below.

In one embodiment, the plurality of depths are defined such that radar waves incident on the internal elements having a phase are reflected out of phase with other reflected radar waves. One such exemplary embodiment is shown in FIGS. 2(b) and 2(c). As shown in FIGS. 2(b) and 2(c), incident radar rays 9 and 17 from a radar emitter simultaneously enter the metal foam. As shown in FIG. 2(b), the incident radar ray 9 enters the metal foam 100, strikes and is reflected from a plurality of internal elements 10, 11, 12, 13, 14 and 15, before escaping the metal foam as an exit radar ray 16. The exit radar ray 16 corresponds to the incident ray 9 after it has been reflected by the metal foam. The exit radar ray 16 is considered to have been dispersed in that, although it exits the metal foam in a direction which may be returned to the emitter, it has a phase which differs from other radar exit rays, such as that shown in FIG. 2(c). FIG. 2(c) schematically shows the incident radar ray 17 striking an internal element 18 at an arbitrary depth and being directly reflected back in the direction of the emitter, in a direction parallel to the route taken by the exit ray 16 in FIG. 2(b). However, as schematically depicted by the different positions of the arrows 16 and 19 relative to the upper surface 102 of the metal foam 100, the exit rays 16 and 19 have a different phase, and thereby will not be detected as a radar return from the object to which the metal foam 100 is applied.

Where a plurality of such incident radar rays such as 1, 9 and 17 strike internal elements of the metal foam 100, in accordance with the present invention, in one embodiment substantially all of such rays are dispersed. Several exemplary modes of dispersion have been described with reference to FIGS. 2(a), 2(b) and 2(c). In one embodiment, at least about 90% of such incident rays are dispersed. In one embodiment, at least about 95% of such incident rays are dispersed. In one embodiment, at least about 97% of such incident rays are dispersed. In one embodiment, at least about 99% of such incident rays are dispersed. In one embodiment, at least about 99.9% of such incident rays are dispersed. In one embodiment, at least about 99.99% of such incident rays are dispersed.

In one embodiment, the radar-reflecting internal elements are disposed at a plurality of depths below an outer surface of the metal foam. The plurality of depths below an outer surface may be defined with reference to FIGS. 2(a), 2(b) and 2(c).

In one embodiment, the internal backbone structure within the foam also allows reflection and diffraction from a plurality of internal surfaces in a variety of directions from shallow depths to deeper depths and at a variety of scattering angles before the radiation emerges from the foam. In this way the incident radiation is further dispersed and its phase further randomized. This embodiment is also shown schematically in FIGS. 2(a), 2(b) and 2(c). As shown in FIGS. 2(a), 2(b) and 2(c), the internal surfaces 2-7, 10-15 and 18 correspond to different depths within the metal foam 100.

In one embodiment, the irregular ligament orientation and ligament depths result in a broadband dispersive scattering, providing radar shielding for a wide range of wavelengths of incident radar wave radiation. This embodiment is also shown schematically in FIGS. 2(a), 2(b) and 2(c). As shown in FIGS. 2(a), 2(b) and 2(c), the internal surfaces 2-7, 10-15 and 18 correspond to irregular ligament orientation and ligament depths within the metal foam 100.

In one embodiment, the three-dimensional, multiply connected metal ligament structure gives many more scattering sites than a substantially two-dimensional rough surface such as in the prior art.

The metal foams of the present invention have a very low reflectivity to incident radar wave radiation. In one example, a 10 ppi (4 ppcm) aluminum alloy foam of thickness ¾″ (1.9 cm) reflects back to the emitter about 0.1% of the 77 GHz radar wave power incident on the surface at normal incidence. This corresponds to a specular power reflectivity of less than −30 dB. This level of transmission of 77 GHz radiation in a single pass through the ¾″ foam sample is not detectable. Practically, substantially all of the incident power from the incident beam is dispersed by the metal foam.

Exemplary metal foams include Al foams of 10 to 40 ppi (about 4 to 16 ppcm), and vitreous carbon (a semimetal) of 20 to 100 ppi (about 8 to 40 ppcm). An example of an open cell aluminum foam with an average of about 10 ppi and about 6% of the density of the parent aluminum is shown in the photograph of Figure I.

The metal foams useful in the present invention can be obtained from ERG Materials and Aerospace Corporation, Oakland, Calif. under the trademark DUOCEL®. In one embodiment, the open cell metal foam is DUOCEL® open cell metal foam, which is available from ERG Materials and Aerospace Corporation, Oakland, Calif. According to information available from ERG, the DUOCEL® open cell metal foam exhibits a continuously connected, open-celled (reticulated) geometry having a duodecahedronal cell shape. DUOCEL® Aluminum Foam Metal is available in a density range of 3%-50% relative to the solid base metal and a cell density of 5, 10, 20 and 40 pores per linear inch, with material density and cell size independently variable. The foam's density, cell size, alloy and ligament structure may be appropriately selected for specific applications. In addition, metal foams may be obtained from Cymat Corp., Mississauga, Ontario, and from Porvair Advanced Materials, Hendersonville, N.C.

In one embodiment, the metal foams of the present invention have an open cell structure and include a plurality of internal elements which scatter or reflect incident radar waves at varying depths below the outer surface. In one embodiment, scattering from within the body of the foam occurs when the pore size is larger than about ⅕ of the wavelength A of the incident radar wave radiation. Such pore size allows penetration of radiation into the foam. This is consistent with a metal mesh model discussed with respect to infrared radiation in M. Kohin, et al “Design of Transparent Conductive Coatings and Filters” in Infrared Thin Films, R. P. Shimshock Ed., Critical Reviews of Optical Science and Technology, vol. CR 39 (1991).

The metal foam presents a random depth, length and ligament orientation to incoming radar wave radiation. Thus, there are a plurality of surfaces at a plurality of virtually continuously varying depths, from which incoming radar waves may be reflected. Due to the random orientation of the internal elements or ligaments, the direction of reflection of the radar waves is randomly varied as well. As a result of these factors, incoming radar waves are scattered in virtually all directions. In addition, due to the random depths of the reflecting surfaces, the incoming radar waves, which are in phase upon arrival, are shifted out of phase with each other upon reflection from the plurality of depths at which the reflective surfaces are located within the foam.

Due to these random factors, i.e., depth, length and ligament orientation, analysis of the effect of the foam on radar wave radiation is complex. In general, the ligament diameter is much smaller than a wavelength and therefore the incoming radar wave radiation is scattered from the randomly oriented ligaments to a wide range of angles. Such scattering is similar to that of Herzian dipole or magnetic dipole antennas. See, for example, S. Ramo, J. R. Whinnery, and T. van Duzer “Fields and Waves in Communication Electronics” John Wiley and Sons, 1967, M. Skolnick, “Radar Handbook Second Edition” McGraw Hill 1990. Since the scattering is broad in angle and there is no phase relationship between ligaments at different depths in the foam, at any angle the scattering is dispersive or diffuse. Even in the small fraction of cases where radar waves are back-scattered directly at the emitter, they are back-scattered from different depths and consequently have a variety of phases which destructively interfere in the direction of the emitter. This is shown schematically in FIGS. 2(b) and 2(c).

A radar-absorbent material may be applied to the metal foam structure as a coating. In one embodiment, the three-dimensional, multiply connected metal ligament structure includes a radar absorbing material coated on internal elements or ligaments in the body of the foam for additional radar return reduction in addition to dispersive scattering. In one embodiment, the coating thickness increases from an outer surface of the metal foam to deeper in the metal foam material. That is, the graded radar-absorbent is applied in a thin layer on structural elements of the metal foam near the outer surface of the metal foam, and is applied in an increasingly thick layer on structural elements deeper into the metal foam until it completely fills the spaces between the elements defining the cells.

In one embodiment, the metal foam further comprises a filler material in open cells of the metal foam. The term “filler material” may include both coatings on internal elements of the metal foam and materials which partially or completely fill open spaces in the metal foam. In one embodiment, the filler material includes a radar-absorbent material. In one embodiment, the three-dimensional, multiply connected metal ligament structure includes radar absorbing materials to be distributed randomly within the body of the foam for additional radar return reduction in addition to the dispersion and phase randomization.

In one embodiment, the radar absorbent filler material includes a lossy material. In one embodiment, the filler material includes a plurality of different lossy materials. Thus, in an embodiment in which the metal foam is filled, different lossy materials may be used for the filler material, so that filler materials having a degree of radar absorbency which increases with depth from the outer surface are used.

In one embodiment, the open structure metal foam provides good heat exchange to the ambient air due to the passage of air through the cells and to the high thermal conductivity of the metal. When, for example, it is applied to the hot cover of an engine compartment of a vehicle, the infrared signature of the hot surface is reduced in addition to providing it with a very low radar signature.

The open cell metal foams of the present invention are self supporting, light weight, and strong. For example, in one embodiment, the metal foam is sufficiently strong that at 6% of bulk density, an aluminum alloy foam can support the weight of a standing man (e.g., 85 kg) without crushing or collapsing.

The fraction of material density of the metal foam is related to the ligament size, to the cell size and to the pore size. For adequate penetration of radiation into the body of the foam, the minimum pore size is set by the longest wavelength radar to be encountered; pore size should be larger than about ⅕ of the wavelength A of the longest wavelength radiation for adequate penetration of the radar wave into the metal foam.

Thus, for example, if the longest wavelength radar waves that the metal foam is expected to encounter are in the X-band of radar waves, the frequency is 8-12 GHz, the maximum wavelength of these radar waves is 3.75 cm (at 8 GHz). According to the above criteria, in order to obtain the desired penetration into the metal foam, the pore size should be greater than about ⅕ of 3.75 cm, or 0.75 cm. A pore size of 0.75 cm corresponds to approximately 1.3 pores per cm or about 3 pores per inch. Thus, a metal foam having a pore size corresponding to 1.3 pores/cm would be effective to disperse X-band and higher frequency radar waves, assuming the metal foam has an adequate thickness.

To achieve adequate internal scattering, the thickness of the foam body L should be large enough that the radar waves cannot penetrate appreciably through a thickness 2L of the foam body. Thus, for example, when a foam of thickness L is applied to a metal surface, radar waves which reach the underlying surface are reflected and make a double pass through the foam. For example, in one embodiment, with 77 GHz incident radiation and 10 ppi Al foam having 6% density, L should be equal to or greater than about 0.3″ (0.75 cm) to provide near-complete scattering of the incident radiation, i.e., little or no reflection of the incident radiation. In general the minimum thickness of foam needed may be established by relatively simple trial and error experiments.

Attachment of Metal Foam to Surfaces

Aluminum metal foams are presently commercially available in tiles of up to 16″×12″×4″ (40 cm×30 cm×10 cm), which can be cut to smaller sizes as needed. Such tiles are available from the above-mentioned sources.

In one embodiment, a surface which otherwise would have high radar reflectivity is covered by pieces of the metal foam in accordance with the present invention to reduce its radar observability.

In one embodiment, the surface may be covered by tiling pieces or tiles of the metal foam onto the surface. In one embodiment, a curved surface may be covered by cutting or bending the metal foam tiles into the appropriate shapes using standard techniques. In another embodiment, a curved surface may be covered by applying appropriately curved pieces of the metal foam onto the surface. Thus, the metal foam may be custom produced to fit a particular substrate shape or, alternatively, the metal foam may be made in a standard shape and size and thereafter be cut and/or reshaped to an appropriate conformation.

The metal foam may be attached by any appropriate method known for attaching such materials to a surface. FIGS. 3(a) and 3(b) are schematic diagrams of two exemplary methods of attaching to a substrate surface tiles of the metal foam of the present invention. The metal foam may be appropriately fastened to the surface, for example, by adhesives or with mechanical fasteners. FIG. 3(a) schematically depicts a method for attaching a pair of metal foam tiles 21, 23 to a substrate surface 20, in accordance with the invention. As shown schematically in FIG. 3(a), an adhesive material 22 may be used to securely attach the metal foam tile to the substrate surface 20.

As shown schematically in FIG. 3(b), a metal foam tile 26 may be attached to a substrate surface 25 by a mechanical fastener. The mechanical fastener 26 in this example is a threaded screw 28. The threaded screw 28 may be inserted into an opening 27 formed in the metal foam tile 26. If needed, a radar-dispersing cover 29 may be applied over the head of the screw 26, so as to avoid any possibility that a radar return signal would be generated from the head of the screw 26.

Although only the foregoing two methods of attachment are shown and described, any suitable means for attaching the metal foam to the underlying surface may be used. Appropriate consideration should be given to the radar reflectivity of any materials used for such attachment.

In the metal foam, the ligaments may have an average thickness within the range of from about 10 microns (μ) to about 5000 μ (5 mm). In one embodiment, the ligaments have an average thickness in the range from about 100 μ to about 2000 μ. In another embodiment, the ligaments have an average thickness in the range from about 200 k to about 1000 k. The average ligament size accounts for differences in ligament thickness at intersections of ligaments (thicker) and in the ligament spans between intersections (thinner). As described above, these ligaments define the pores between the cells of the open cell metal foam, in addition to defining the open cells of the metal foam.

Exemplary vehicles to which the metal foam may be applied (in the form of tiles or otherwise) include aircraft (both fixed wing and helicopters), spacecraft, missiles, watercraft such as ships, submarines, landing craft, hovercraft, etc, and land vehicles such as automobiles, trucks, troop carriers, tanks, Humvees and any other military vehicle, equipment or other object which would be subject to detection by radar and which needs to be shielded from detection by radar. Included within the definition of military-related vehicle are artillery pieces, rocket launchers, missile launchers and other equipment. Low radar return enclosures, both portable and fixed, may be constructed from metal foam tiles for concealment of vehicles and objects, in accordance with the invention. The radar signature of a ship superstructure may be reduced by covering surfaces thereof with the metal foam of the present invention. Because it is light weight, metal foam cladding may be applied to low speed, fixed wing aircraft and helicopters to significantly reduce their radar signatures.

The following exemplary embodiments, and others hereinabove, are provided to further explain the invention and are not intended to be limiting thereof. Suitable materials, pore sizes and other features of the open cell metal foams of the present invention may be suitably selected by those of skill in the art.

In one exemplary embodiment, a military vehicle such as a tank is expected to be subjected to enemy radar of frequency 12 GHz or greater corresponding to Kᵤ-band and higher frequency. As noted above, 12 GHz and higher radar frequency corresponds to a radar wavelength A of about 2.5 cm or less. Therefore the pore size of the open cell metal foam to be applied the vehicle skin, defined by the λ/5 criterion, would be a pore size equal to about 0.5 cm or about 2 ppcm or 5 ppi. Thus, for example, the vehicle may be covered by a light weight aluminum alloy 5 ppi metal foam. The foam covering may be painted black or with camouflage colors to reduce its visibility to the naked eye. Various metal foam materials may be substituted for the aluminum to confer other advantages such as greater corrosion resistance or increased strength.

In another exemplary embodiment, the superstructure of a military ship is expected to be subjected to enemy radar of frequency 4 GHz or greater corresponding to C-band and higher frequency. As noted above, 4 GHz and higher radar frequency corresponds to a radar wavelength A of about 7.5 cm or less. Therefore the pore size of the open cell metal foam to be applied to the ship superstructure, defined by the λ/5 criterion, would be a pore size equal to about 1.5 cm or about 0.67 ppcm or about 1.7 ppi. Thus, for example, the superstructure may be covered by a metal foam of 1.7 ppi. For such an application, the metal foam may be composed of steel or a corrosion resistant alloy such as stainless steel. As in the case of the vehicle, the foam covering could be painted black or some other color to reduce its visibility to the naked eye and to protect it from corrosion by water spray. Various other foam materials may be substituted to confer other advantages such as lighter weight.

Although the invention has been shown and described with respect to certain embodiments, equivalent alterations and modifications will occur to others skilled in the art upon reading and understanding this specification and the annexed drawings. In particular regard to the various functions performed by the above described integers (components, assemblies, devices, compositions, steps, etc.), the terms (including a reference to a “means”) used to describe such integers are intended to correspond, unless otherwise indicated, to any integer which performs the specified function of the described integer (i.e., that is functionally equivalent), even though not structurally equivalent to the disclosed structure which performs the function in the herein illustrated exemplary embodiment or embodiments of the invention. In addition, while a particular feature of the invention may have been described above with respect to only one of several illustrated embodiments, such feature may be combined with one or more other features of the other embodiments, as maybe desired and advantageous for any given or particular application.

What is claimed is:

1. A material of construction comprising a radar-dispersing open cell metal foam.

2. A material of construction as in claim 1, wherein the metal foam comprises a plurality of radar-reflecting surfaces.

3. A material of construction as in claim 2, wherein the radar-reflecting surfaces are at a plurality of depths below an outer surface of the metal foam.

4. A material of construction as in claim 1, wherein the radar-dispersing metal foam reflects incident coherent radar waves as non-coherent waves.

5. A material of construction as in claim 2, wherein the surfaces are oriented to reflect radar waves incident thereon in a plurality of directions.

6. A material of construction as in claim 2, wherein the surfaces are disposed on a reticulated backbone structure comprising a plurality of multiply connected ligaments.

7. A material of construction as in claim 6, wherein the ligaments define open cells in the metal foam.

8. A material of construction as in claim 6, wherein radar waves incident on the ligaments are reflected in a plurality of directions.

9. A material of construction as in claim 1, wherein the metal foam comprises open cells connected by pores having an average diameter such that the metal foam comprises from about 2 pores per cm to about 50 pores per cm.

10. A material of construction as in claim 1, wherein the metal foam comprises pores having an average diameter larger than about ⅕ wavelength of a maximum wavelength incident radar wave.

11. A material of construction as in claim 1, wherein the metal foam has an average density from about 2% to about 25% of the density of the metal.

12. A material of construction as in claim 1, wherein the metal foam comprises one or more of Al, Cu, Ni, Si, Ti, Fe, Pt, Ag, and alloys of two or more of these, and steel, stainless steel, brass, Hastalloy, NiChrome, Inconel, FeCrAIY and vitreous carbon.

13. A material of construction as in claim 1, wherein the metal foam has a thickness in the range from about 0.1 cm to about 20 cm.

14. A material of construction as in claim 1, wherein the metal foam further comprises a material coated on surfaces of the metal foam.

15. A material of construction as in claim 14, wherein the material is radar-absorbent.

16. The material of construction of claim 1, wherein the radar-dispersing metal foam has an average density of the metal foam varies from about 2% to about 25% of the material density of the parent material.

17. A vehicle having the radar-dispersing metal foam of claim 1 on at least one surface.

18. A vehicle as in claim 17, wherein the metal foam has a form of a tile.

19. A radar-dispersing metal foam comprising open cells having an average pore diameter such that the metal foam comprises from about 0.2 pores per cm to about 60 pores per cm, the open cells comprising a plurality of radar-reflecting surfaces, wherein the metal foam reflects incident coherent radar waves as non-coherent waves and/or in a plurality of directions.

20. The radar-dispersing metal foam of claim 19, wherein an average density of the metal foam varies from about 2% to about 25% of the material density of the parent material.

21. The radar-dispersing metal foam of claim 19 having a form of a tile.

22. A vehicle having the radar-dispersing metal foam of claim 19 on at least one surface.

23. A radar-dispersing metal foam comprising open cells with an average pore diameter larger than about ⅕ wavelength A of a maximum wavelength incident radar waves, the open cells comprising a plurality of radar-reflecting surfaces, wherein the metal foam reflects incident coherent radar waves as non-coherent waves and/or in a plurality of directions, and an average density of the metal foam varies from about 2% to about 25% of the material density of the parent material.

24. A vehicle having the radar-dispersing metal foam of claim 23 on at least one surface.
